(19) United States
(12) Patent Application Publication
(10) Pub. No.: US 2002/0181336 A1
(43) Pub. Date: Dec. 5, 2002

(54) Portable timer-alarm

(76) Inventor: Donald Michael Shields, St.Paul, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/873,776

(22) Filed: Jun. 4, 2001

(51) Int. Cl. G04F 8/00; G04F 10/00

(52) U.S. Cl. 368/109

(57) ABSTRACT

In accordance the embodiments of the present invention there is provided an alarm apparatus for transmitting an alarm tone to a user at a predetermined time so as not to disturb other persons in the nearby vicinity. The timer alarm apparatus comprises a timer set assembly and an alarm assembly configured to be disposable in the user's auditory passage. The alarm assembly includes a timing circuit, a power source, and an alarm tone generation assembly. The alarm assembly may be configured to form an earplug, an ear clip, or be incorporated into various types of hearing assist devices. The alarm assembly may be provided with an alarm set indicator and volume adjusting structure. The timer set assembly may include a time of day readout, set controls for hour, minute, time set, and optionally volume. The timer set assembly may resemble a small portable device capable of being carried by the user in a purse or pocket. The timer set assembly may also take the form of an alarm clock or alarm clock radio.

### FIELD OF THE INVENTION

The present invention relates to alarm devices, and more particularly to an alarm device capable of being worn in the ear and a method for same.

### BACKGROUND OF THE INVENTION

Alarm devices are commonly used by persons desiring to receive an alert after a preset time expires or at a particular time of the day. One such device is an alarm clock, which many people use to wake them in the morning at a predetermined time of day. Another such device is a timer coupled with an alarm. The timer/alarm is preset with a predetermined amount of time that counts down and sounds an alarm or alert tone when completed.

The alarm (alert) tones produced by these devices must be sufficiently loud to gain the attention of the user. For example, the alarm tone must awake a user who is asleep. When many such users are within a close proximity to each other and desire to be alerted at differing times, the resulting multiple alarm tones generated by multiple alarm devices will disturb many of the users to whom the particular alarm does not pertain. Hence, there is a need to provide an alarm device that is perceptible by a user and that will not disturb other persons in the nearby vicinity.

U.S. Pat. Nos. 4,821,247 and 6,067,006 disclose an ear-mounted alarm clock and a personal audible alarm respectively. These devices are intended to be worn by an individual user. At the time the alarm is set, an audible signal is presented into the user's ear canal, thus alerting the user. Because of its location in the user's ear, the volume of the alarm tone can be much less than the volume of an alarm that broadcasts its tone into the environment. Such an alarm tone will not disturb persons in the nearby vicinity. The ear device control functions allow the user to set the predetermined amount of time in terms of the time for the alarm to sound. Volume and a clock time readout are also present. Because the alarm device is small enough to be used in the ear of the user, the control functions are necessarily miniaturized and placed in close proximity to each other. Such small and cramped controls can present ergonomic difficulties for many users. Moreover, due to the presence of these controls in the earpiece, further miniaturization of the controls exacerbates these ergonomic problems.

U.S. Pat. No. 6,008,720 discloses a portable timer alarm with ear attachment. The alarm device is provided with multiple switches. The user actuates the switches to enter a desired predetermined amount of time before an alarm sound is generated. Each switch corresponds to a certain time interval. There is no dial or display, thereby presenting a minimum number of controls so as to improve the ergonomics of this device. However, this ear device has limited functionality choices due to its small number of controls. Thus, there is a need to provide a personal ear mounted alarm device that has the full functionality of a traditional alarm while enjoying the benefits of an alarm that can be worn in a user's ear.

U.S. Pat. No. 5,894,455 discloses an alarm clock system with ear insert, wherein a base unit transmits an alarm signal to a receiver in the user's ear. The receiver, in turn, sounds an alert tone. This design eliminates the ergonomic and control problems present in the one piece personal alarm design. The remote ear piece is merely a receiver capable of receiving an alert signal produced by a base transmitting unit. The base unit may resemble a traditional alarm clock. The signal is transmitted from the base transmitter to the ear piece receiver via radio waves. Thus, when the alarm is on, the ear receiving piece must be in an on condition to receive any signals transmitted by the base unit. The constant on condition causes the receiver to have a high power consumption and thus require a larger power source. Additionally, in certain applications the radio frequency waves may pose interference problems with the surroundings, such as on airplanes. The base unit must also be within a close proximity to the receiver due to the low power of the radio frequency transmission.

Therefore, there is an ongoing need to provide an ear-mounted personal alarm device having improved ergonomics and control functions and that overcomes the disadvantages of the prior art.

### SUMMARY

In accordance with the embodiments of the present invention, there is provided an alarm apparatus for transmitting an alarm tone to a user at a predetermined time so as not to disturb other nearby persons. The alarm apparatus may also eliminate, or minimize, ambient sounds from being heard by the user. The present timer alarm apparatus includes a timer set assembly and an alarm assembly. The alarm assembly may be configured to be at least partially disposed in the user's auditory canal. The alarm assembly may include a timing circuit, a power source, and an alarm tone generation assembly and may be configured to form an earplug, or an ear clip, or may be incorporated into various types of hearing assist devices. The alarm assembly of one embodiment may be provided with an alarm set indicator and volume adjustment means. The timer set assembly may include a time of day readout and set controls for hour, minute, time set, and optionally volume. The timer set assembly may resemble a small portable device capable of being carried by the user in a purse or pocket or may take the form of an alarm clock, an alarm clock radio, or a hearing assist device control.

Additional objects, advantages, and features of various embodiments of the present invention will be set forth in part in the description which follows, and in part will become apparent to those of ordinary skill in the art upon examination of the following or may be learned by practice of the invention without undue experimentation. The objects and advantages of various embodiments of the present invention may be realized and attained by means of the instrumentalities and combinations particularly pointed out in the appended claims.

### BRIEF DESCRIPTION OF THE DRAWINGS

FIG. 1 is a perspective view of an alarm assembly according to a first embodiment of the present invention in the form of an ear plug;

FIG. 2 is a perspective view of an alarm assembly earpiece according to a second embodiment of the present invention;

FIG. 3 is a perspective view of a third embodiment of this invention, in which a hearing aid incorporating the alarm assembly according to an embodiment of the present invention is depicted;

FIG. 4a is an external view of an alarm assembly according to an embodiment of the present invention shown partially inserted in a user's ear;

FIG. 4b is a cross sectional view of a user's ear showing the present alarm assembly partially inserted therein;

FIG. 5 is a perspective view of a timer set assembly according to a first embodiment of the present invention;

FIG. 6 is a perspective view of a timer set assembly according to a second embodiment of the present invention;

FIG. 7a is a perspective view of a timer set assembly incorporated into a portable alarm clock according to a third embodiment of the present invention;

FIG. 7b is a bottom view of the timer set assembly of FIG. 7a;

FIG. 8 is a perspective view of an alarm clock radio incorporating the timer set assembly according to a fourth embodiment of the present invention;

FIG. 9 is an electrical component schematic of the timer set assembly according to one embodiment of the present invention;

FIG. 10 is a detailed electric component schematic of the layout of FIG. 9;

FIG. 11 is an electrical component schematic of one embodiment of the alarm assembly earpiece of this invention;

FIG. 12 is a detailed electrical component schematic of the layout of FIG. 11;

FIG. 13 is an electrical schematic showing inductive couplings incorporated into the present timer set assembly and alarm assembly;

FIG. 14 is a layout of a timer set assembly of an embodiment of the present timer set assembly with hearing aid functions incorporated therein; and

FIG. 15 is a schematic layout of a hearing aid incorporating alarm functions according to the present invention.

It is understood that the above-described figures are merely illustrative of the present invention and are not contemplated to limit the scope thereof.

### DETAILED DESCRIPTION OF THE INVENTION

Any references to such relative terms as front, back, right, left, top, bottom, upper, lower, horizontal, vertical, or the like, are intended for convenience of description and are not intended to limit the present invention or its components to any one positional or spatial orientation. Moreover, all dimensions of the components in the attached figures may vary with a potential design and the intended use of an embodiment of the invention without departing from the scope of the invention.

In one embodiment, the present invention includes an alarm assembly and a timer set assembly. The alarm assembly may be configured to be operably inserted into a user's ear and may include an internal timing mechanism, an alarm sound generating mechanism, and structure for receiving and processing a signal from the timer set assembly. The processed signal includes instructions for the length of a time interval. The alarm assembly also includes structure for determining when the time interval (period) has elapsed and structure for actuating the alarm sound in response to the elapsed time interval. The timer set assembly includes structure of determining the length of the time interval and for generating a signal to be transmitted to the alarm assembly. The alarm assembly and timer set assembly have structure to receive and transmit the signal, the structure configured for infrared, hardwired, electronic, radio frequency, electromagnetic, or inductive magnetic transmission.

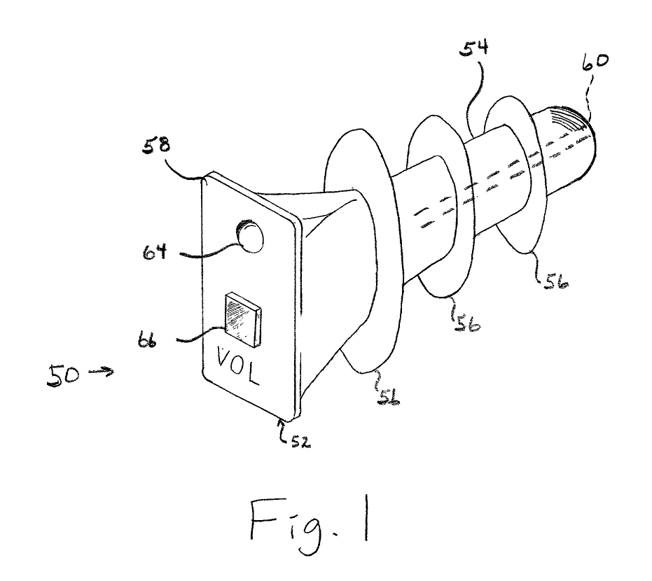

FIGS. 1, 2, and 3 depict three embodiments of the present alarm assembly at 50. In the context of FIGS. 1, 2, and 3, the present alarm assembly may also be referred to as the earpiece 50. Referring to FIG. 1, the earpiece 50 is molded into the shape of an earplug 52. The earplug 52 includes an elongated section 54 with a plurality of noise suppression ribs 56 therearound and a base 58. The elongated section 54 defines an aperture 60 through which the alarm sound is transmitted into the user's auditory canal.

When inserted, at least partially, into the user's auditory canal, the earplug 52 is configured to eliminate, or minimize, transmission of ambient noise into the user's auditory canal, so that the user will be undisturbed by these sounds, e.g., while sleeping. In one embodiment, an indicator light 64 and a volume adjustment apparatus 66 are disposed in the base 58. The indicator light 64 may be a light emitting diode (LED), which indicates to the user that the alarm assembly 50 has been successfully set with a predetermined amount of time and that an alarm therein will sound after of the predetermined amount of time has elapsed. The LED may flash for a period of a few seconds when the predetermined amount of time has been “loaded” into the alarm assembly 50. Alternatively, the LED may flash intermittently or may stay illuminated throughout the timing period. The volume adjusting apparatus 66 may be a single depressible button. When depressed, the volume adjusting apparatus 66 progressively increases or decreases the volume of the emitted alarm tone when heard by the user.

The earplug 52 and other alarm assemblies of this invention may be constructed of suitable moldable synthetic resins or rubber, resulting in a substantially rigid or semi-rigid structure so as to allow for insertion, removal and user comfort. The noise suppression ribs 56 may be soft flexible rubber or an equivalent, thereby allowing a snug, preferably comfortable, fit to suppress transmission of ambient noises into the user's auditory canal.

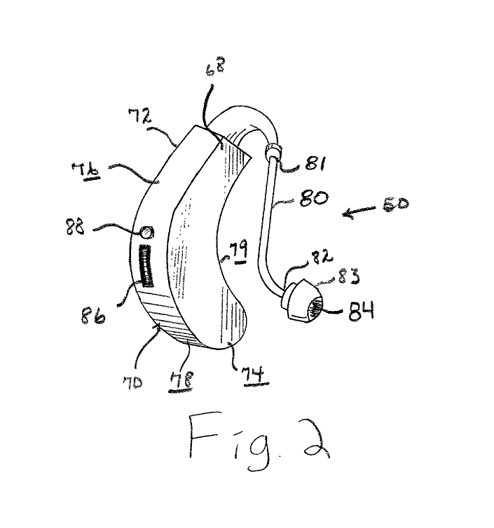

Referring to FIG. 2, another embodiment of the present alarm assembly 50 is depicted as an external mount earpiece 70. In this embodiment, the external mount earpiece 70 includes an elongated housing 72, which displays a first surface 74, an opposite second surface 76, and respective opposite longitudinal third and fourth surfaces 78 and 79. A sound transmission tube 80 is mounted to the elongated section 72 at a first end 81 in this embodiment. The sound transmission tube 80 also terminates in a second end 82, at which a fitting 83 is joined thereto and through which a bore 84 is defined. The fitting 83 is sized to be snugly accommodated in the user's auditory canal. The bore 84 also extends through the tube 80 to the housing 72. In operation, the alarm tone is transmitted from the housing 72, through the bore 84, to the user's auditory canal. The externally mounted earpiece 70 is configured to be secured next to the user's ear when the tube 80 and fitting 83 are in place in the user's auditory canal. When worn on the user's left ear, the housing first surface 74 rests against the user's head and the housing second surface 76 and fourth surface 79 rest against the backside of the user's ear. When worn on the user's right ear, the first surface 74 and fourth surface 79 rest against the backside of the user's ear and the second surface 76 rests against the user's head.

The housing third surface 78 of the external mount earpiece 70 may accommodate a volume adjustment device 86 and an indicator light 88. The volume adjustment device 86 may be a wheel, which can be rotated to increase or decrease the volume of the alarm tone generated within the earpiece 70. The indicator light 88 may be an LED, which illuminates to alert the user that the earpiece 70 has been set with a predetermined amount of time and that the alarm will sound when the predetermined amount of time has elapsed and as more fully described herein.

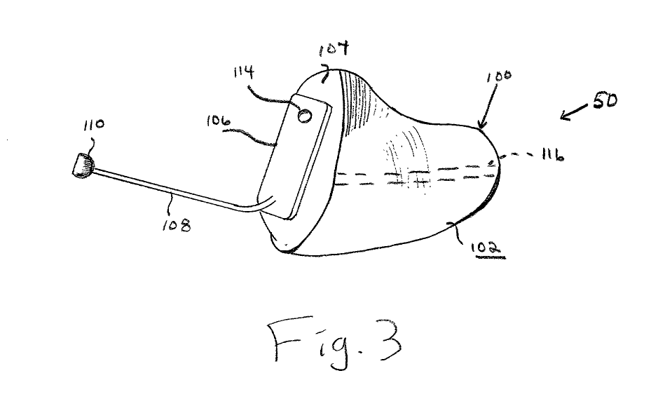

Referring to FIG. 3, another embodiment of the present alarm assembly 50 is depicted as a hearing aid 100. The hearing aid 100 may display a contoured surface 102 and a base 104 and may include a base plate 106, a handle 108, and a handle tip 110. The contoured surface 102 is dimensioned and configured so that the hearing aid 100 is insertable into the user's auditory canal and snugly fits the contours present therein. The base plate 106 is mounted to the base 104. The handle 108 may be unitary (or otherwise integral) with the base plate 106. The tip of the handle extension 110 allows the user to easily and more securely grip and manipulate the hearing aid 100. Obviously, the hearing aid 100 may be utilized in the absence of a handle 108 or handle extension 110 and still be within the spirit and scope of the present invention.

The base 104 and/or the base plate 106 of the hearing aid 100 may be provided with an indicator light 114 to indicate an “armed” (loaded) condition of the present alarm assembly as discussed above. An armed or loaded condition is considered to occur whenever the present alarm assembly is loaded with a predetermined amount of time (time interval) from the present timer setting assembly and set in a countdown-type mode so that an alarm tone sounds at the conclusion of the predetermined amount of time. The hearing aid 100 defines a bore 116 therethrough. Sound waves are transmitted through the bore 116 to the user's auditory canal.

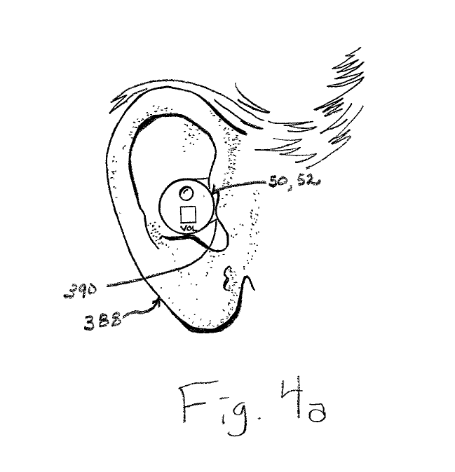

Referring now to FIGS. 4a and 4b, a user's ear 388 is shown with the alarm assembly 50 as described above. The alarm assembly 50 has been operably inserted into an auditory canal 390 of the user's ear 388. The noise suppression ribs 56 flex to conform to the contours present in the user's auditory canal 390 for a snug, preferably comfortable fit. The noise suppression ribs 56 eliminate or greatly reduce transmission of ambient sound waves from the user's environment into the user's auditory canal 390.

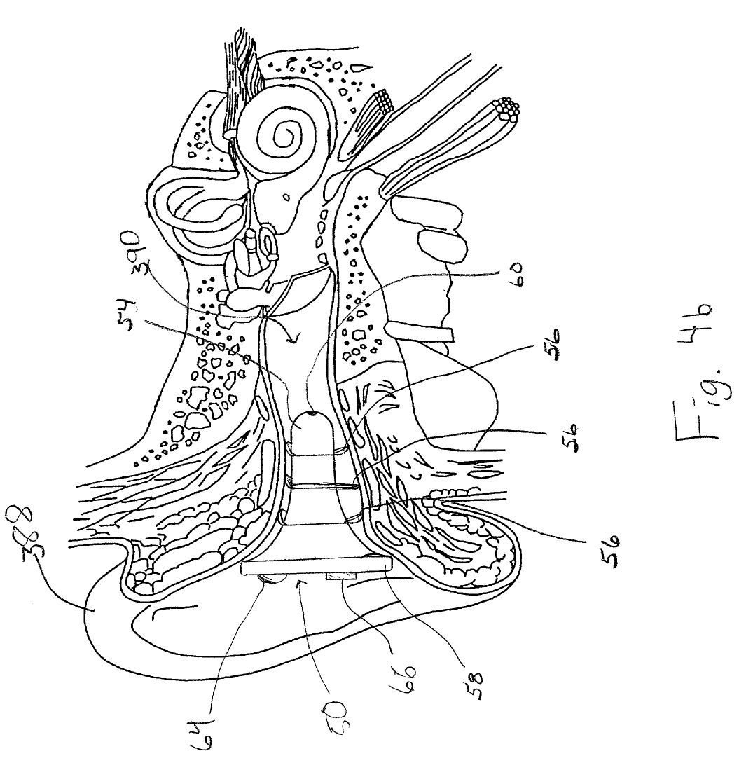

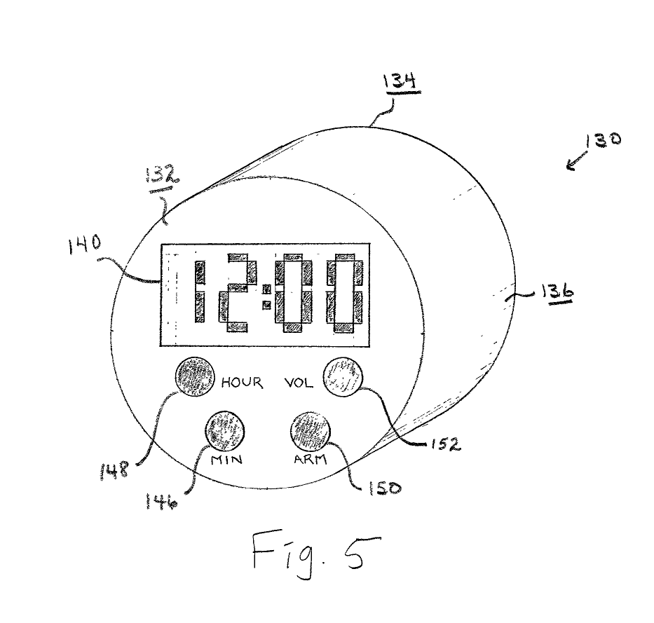

FIGS. 5-8 depict embodiments of timer setting assemblies of the present invention. Referring specifically to FIGS. 5 and 6, respective timer setting assemblies 130 and 131 display a top surface 132, a bottom surface 134, and a longitudinal (side) surface 136. The timer setting assembly 130 resembles a cylinder and the timer set assembly 131 resembles a parallelepiped in shape. The timer set assemblies 130 and 131 are provided with a digital display 140 for displaying a time interval as discussed above. The timer setting assemblies 130 and 131 may further include a plurality of functional devices, e.g., a minute set device 146, an hour set device 148, an alarm-arming device 150, and a volume adjusting device 152. The functional devices in this embodiment may be depressible switches. These timer setting assemblies may be dimensioned so that they are easily carried, e.g., in a user's pocket or purse during travel.

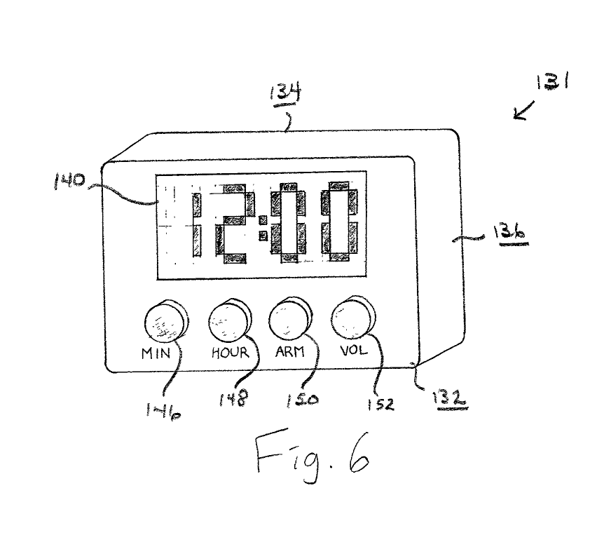

FIGS. 7a and 7b depict another embodiment of the present timer setting assembly, partially configured as a portable alarm clock 160. This embodiment is battery powered for enhanced portability. A battery cover 162, proximate a lower surface 163, allows the user to access the battery powering the timer setting assembly. Also in this embodiment, the timer setting assembly 160 includes a volume adjusting device 164 controlling the volume of the alarm emitted. This embodiment is further provided with a speaker grate 168 to allow an internal speaker to emit an audible alarm tone. Other functional devices provided are a digital display 170, respective hour and minute setting devices 172 and 174, and an alarm-setting device 176 (denoted as “ARM”). These functional devices have similar functions to similar devices discussed below.

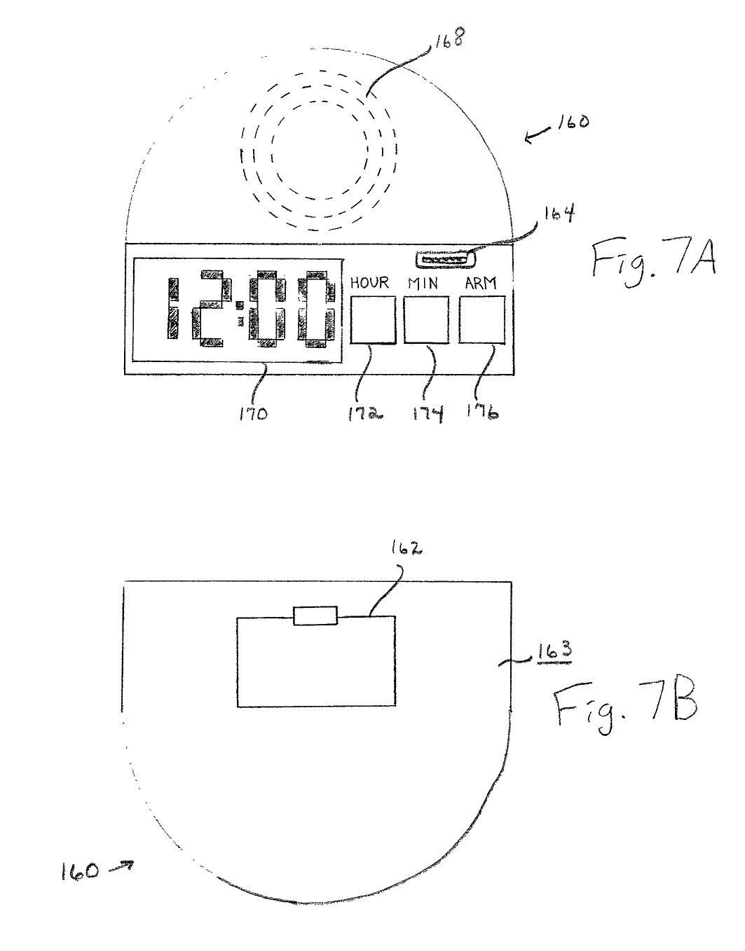

Referring to FIG. 8, yet another embodiment of the present time setting assembly is partially configured as an alarm clock radio 180. This embodiment is powered by house current and connected thereto by a power cord 182. Radio frequency tuning is accomplished by operating a tuning knob 184 and visually indicated by a tuning indicator 186. An alarm-on indicator 188 indicates that this embodiment is set to emit an alarm at the end of a predetermined time interval as indicated by a digital display 190. In some embodiments the digital display 190 indicates the time when not being used to upload a time interval to the present alarm assembly. The alarm on the indicator 188 may be an LED. The time setting assembly 180 is further provided with a band select device 192 for switching between amplitude modulation (AM) and frequency modulation (FM) radio frequency bands. An alarm volume adjustment knob 194 and a radio volume adjustment knob 195 may adjust the volume of the alarm sound and the radio sound. Alarm tones and music may be emitted by an internally mounted speaker, which emits sound waves through the top face 196 of the alarm clock radio 180, via a speaker grate 197. A snooze switch 198 stops this embodiment from emitting an alarm sound and resets it to emit an alarm sound at the end of a delay period, e.g., 10 minutes. Functional features for uploading a time interval to the present alarm assembly include respective hour and minute setting devices 199 and 200 and an arm device as more fully discussed below.

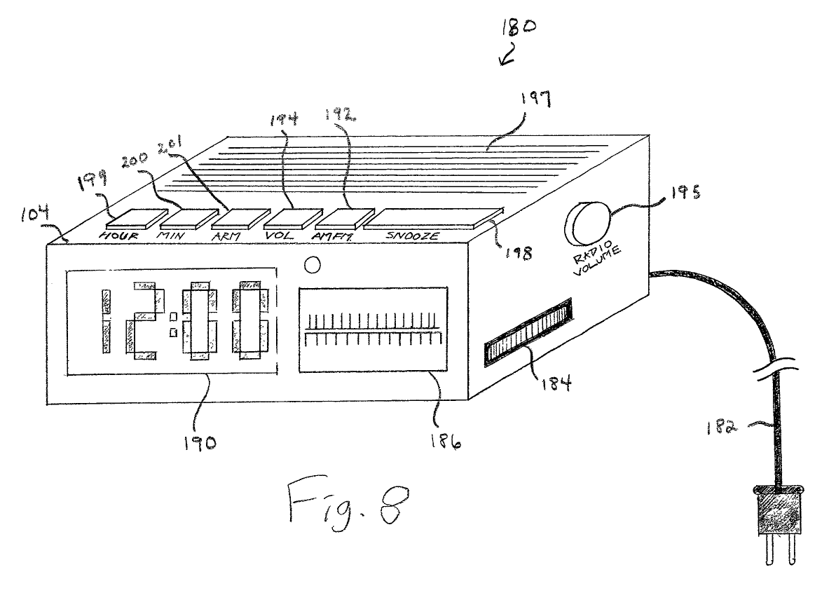

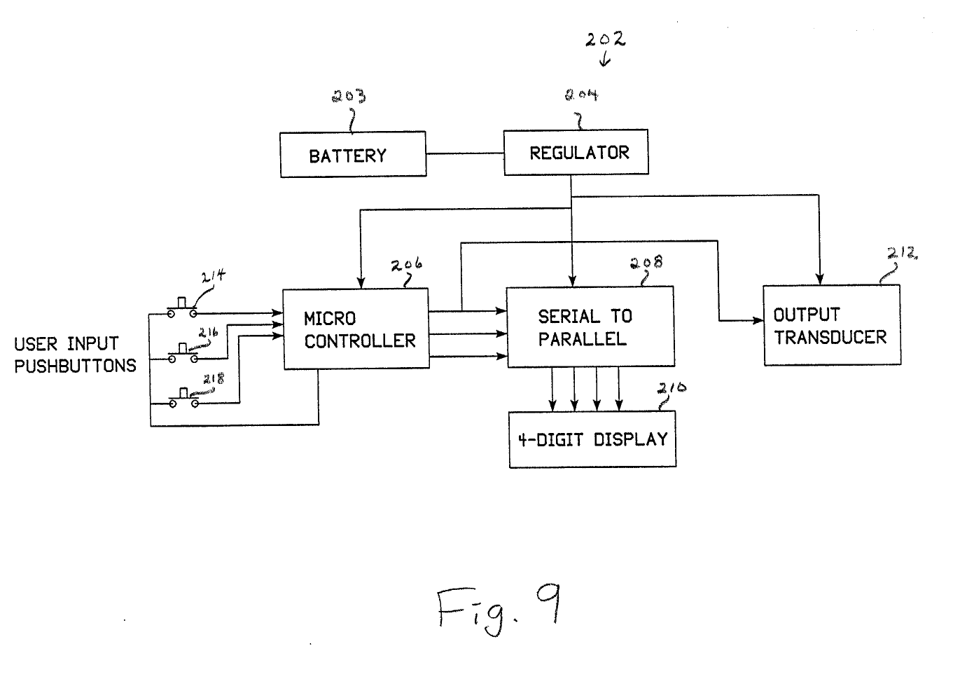

Electrical diagrams for the present timer set assembly are depicted in FIGS. 9 and 10 generally at 202. A battery 203 is connected to a voltage regulator 204. The voltage regulator 204 maintains a stable voltage value suitable to operate the circuit components of the present timer setting assembly. In one embodiment, the voltage regulator 204 is a 7805-type voltage regulator known to those of ordinary skill in the art. Power is provided by the battery 203 through the voltage regulator 204 to a microcontroller 206, a serial-parallel converter 208, a display 210, and an output transducer 212. The user actuates a plurality of input devices, such as an hour set device 214, a minute set device 216, and a loaded transmission (or arming) device 218 to program a predetermined time interval into the present timer set assembly to be uploaded into the alarm earpiece of this invention. The hour set device 214 allows the user to input a desired number of hours; the minute set device 216 allows the user to input a desired amount of minutes; and the loaded transmission device 208 allows the user to activate the time uploading assembly (means) for transmitting the determined time interval to the earpiece.

The input devices 214, 216, and 218 maybe electrically connected (or otherwise in electrical communication) with the microcontroller 206, which accepts data input from these input devices for processing. The microcontroller 206 may be a commercially available PIC12C508 model microcontroller. However, other suitable equivalents are known to those of ordinary skill the art. The microcontroller 206 accepts and converts the input data to a form suitable to drive the digital display 210. The digital display 210 includes a plurality of individual units (digits) 211 for displaying a time interval length, e.g., hours and minutes. The microcontroller 206 additionally formats the input data to serially transmit the formatted input data to the serial-parallel converter 208.

The formatted data from the microcontroller 206 are transmitted to the serial-parallel converter 208. The serial-parallel converter 208 accepts the formatted data as a serial stream and converts the formatted data to a parallel stream, as required by the display 210 in this embodiment. The output transducer 212 is a circuit portion converting the serial data into a form for wireless transmission to the earpiece. The wireless transmission form can be infrared optical, magnetic induction, modulated radio frequency, or other equivalents known to those of ordinary skill in the art. Therefore, the specific structure of the output transducer 212 will vary, depending on the wireless transmission form employed. Moreover, those of ordinary skill the art will recognize that the term “transducer” is generic for any circuit portion transforming one type of signal to another type of signal.

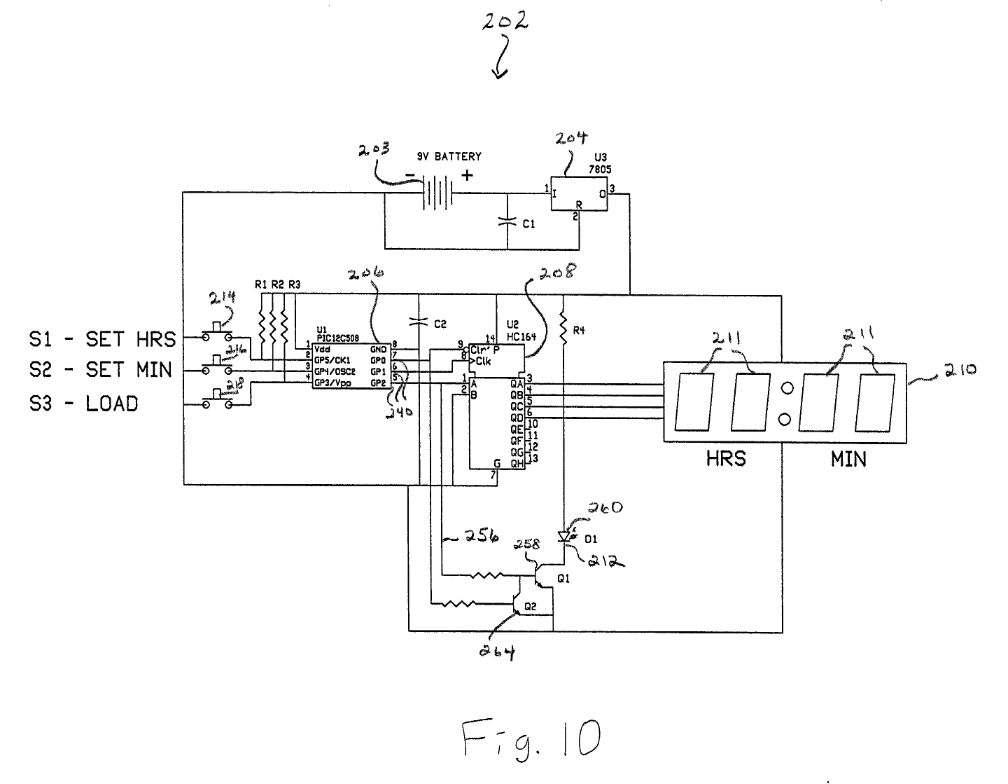

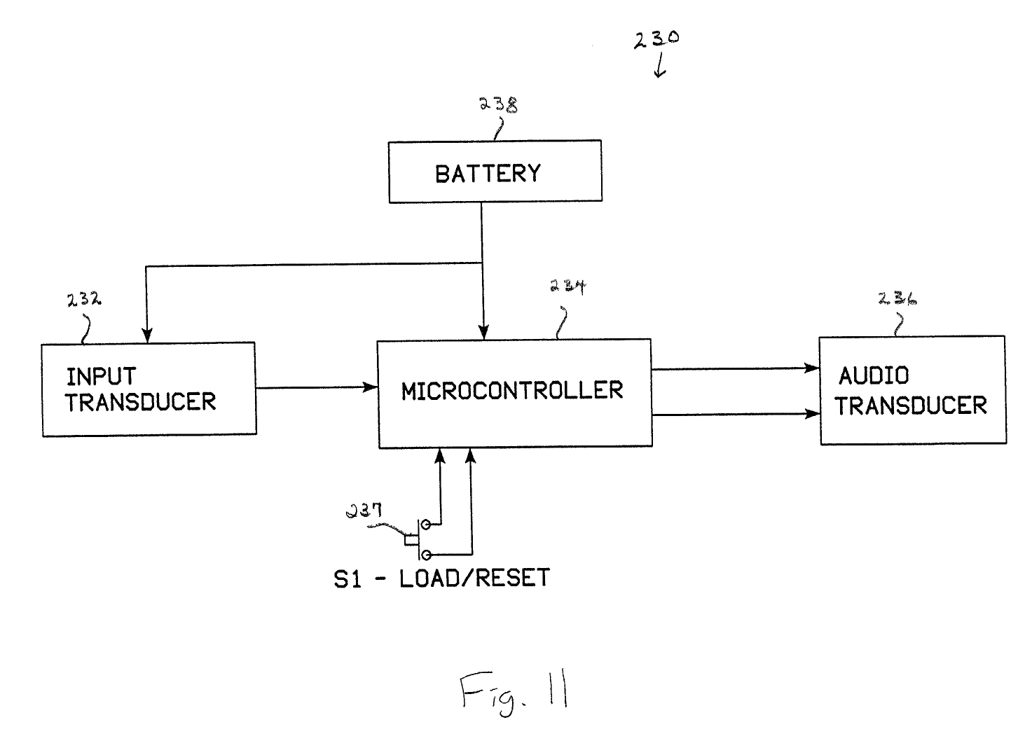

Referring to FIGS. 11 and 12, one embodiment of an electrical component diagram of the present alarm assembly is depicted generally at 230. The alarm assembly 230 may include an input transducer 232, which is electrically connected to a microcontroller 234. The alarm assembly 230 may further include an audio transducer 236 and a power source such as a battery 238 for powering these components.

In operation, the electrical circuit for the present timer setting assembly (shown in FIG. 10) receives signal input from the input devices 214, 216, and 218, representing respectively hours, minutes, and loaded status. These input signals “pull low” the ports 240 of the microcontroller 206 when the user depresses the devices 214, 216, and 218. The switch 214 allows the number of hours to be incremented; the switch 216 allows the number of minutes to be incremented; and the switch 218 is used to initiate data transmission to the present earpiece alarm assembly. In other embodiments, a different type of input device, such as a knob or a rotary encoder, could be used to initiate data transmission.

The microcontroller 206 is normally in a “sleep” mode with minimal power consumption from the battery 203. The state change on an input port 240, effected by operating an input device 214, 216, and 218, “wakes up” the microcontroller 206. The “awakened” microcontroller 206 “accepts” the input commands from the input devices 214 and 216 and produces a data stream. The data stream is fed to the serial-parallel converter 208, causing the display 210 to indicate the chosen time, e.g., in terms of hours and minutes, on the display 210 on the digits 211.

When a load transmit device 218 is depressed, the display 210 is cleared and a serial data line 256 operates a first transistor switch 258, which may prompt an infrared LED 260 to flash accordance with the serial data. The serial data are formatted by the microcontroller 206 for transmission to a receiving portion 232 of the present earpiece alarm assembly (FIG. 12). During normal serial transmissions from the microcontroller 206 to the serial-parallel converter 208, the first port 240 remains at a “high” condition and a second transistor switch 264 prevents operation of the first transistor switch 258. During data transmission, the first port 240 goes to a “low” condition, which clears the serial-parallel converter 208 and the display 210 and which turns off the second transistor switch 264, thereby allowing the first transistor switch 258 to operate.

After a predetermined period of inactivity, the microcontroller 206 returns to the “sleep state” until a new command is introduced by the user via input devices 214, 216, and 218. The battery depicted in FIG. 10 may be a 9-V battery because of its convenience, cost, and wide availability from retail sources. The circuits represented by microcontroller 206, serial-parallel converter 208, display 210, and output transducer 212 may require 5 V for operation. Hence, the voltage regulator 204 may provide the desired voltage to these circuits.

When the present earpiece alarm assembly is being programmed by the present timer setting device, the alarm assembly and timer setting devices are brought into close proximity so that output emissions can be transferred therebetween. Infrared or magnetic output emissions from the present timer set assembly are sensed by the input transducer. The output transducer 212 of FIG. 10 is an output LED 260. The first transistor switch 268 sets a threshold for sensing the voltage changed in the output LED 260, so that the voltage corresponding to the infrared pulses is unambiguous at the drain terminal 268 of the first transistor switch 258 and is, hence, acceptable to the microcontroller 234. By requiring close proximity during programming and by setting a high threshold, the present earpiece alarm assembly will not be susceptible to interference from ambient electromagnetic (e.g., infrared) energy, either during programming or during the remainder of its function.

The microcontroller 234 of the present alarm assembly in FIGS. 11 and 12 is normally in a “sleep” mode with very low power consumption. When voltage transitions occur at port GP3 241, due to received data, the microcontroller 234 “wakes up.” The received data are processed in the microcontroller 234 to determine the endpoint of a counter. Upon receiving this data, the microcontroller 234 stores the data until the hour set device 214 is depressed. The microcontroller 234 then starts counting cycles of an oscillator, which is an internal function of the microcontroller 234. At the programmed end of the count, the microcontroller 234 produces a signal at ports 243 (GP0) and 242 (GP1). This signal is in the form of an approximately sampled sine wave and causes the audio transducer 236 to emit a tone into the user's ear.

The set device, or volume set, 237 on the present earpiece alarm assembly may serve two purposes. For example, pressing the set device 237 a first time begins a countdown as described above. When the alarm is sounding, pressing the set device 237 turns the set device 237 off and returns the microcontroller 234 to the sleep state. Additionally, the set device 237 can be configured to allow the user to perform volume adjustment of the audio transducer as described above. Preferably, as the user presses the set device or volume set 237, the volume will increase by a predetermined, stepped amount to a maximum value. Pressing the set device or volume set 237 a second time will cause the volume to decrease by the same stepped amount to a minimum value.

The input transducer 232 of the alarm assembly 230 is the reciprocal of the output transducer 212 of the timer setting assembly 202. The input transducer 232 receives signals generated by the output transducer 212 and transfers the received signals to the microcontroller 234. The microcontroller 234 is configured to set the time interval for countdown purposes. When the time interval reaches zero, the microcontroller 234 generates an electrical signal, e.g., with a sine waveform as described above. The electrical signal is sent to the audio transducer 236 to produce a mechanical vibration generating an audible alarm sound for transmission to the auditory canal of the user. The circuit 230 is powered by a battery 238, which may be a 3-V lithium battery.

A resistor R4 270 and capacitor C2 271 may be the timing components for the internal oscillator. The resistor R4 270 and capacitor C2 271 are chosen to operate the microcontroller 234 at a low clock frequency, such as 32 kHz, thereby greatly reducing power consumption. Internal comparator thresholds of the oscillator are proportional to the battery voltage, as is the current through the resistor R4 270. The result is that the gradual decline in the battery voltage with use does not seriously degrade the timing accuracy. The audio transducer 236 of this embodiment is a typical “ear bud” or hearing aid type of loudspeaker device known to those of skill in the art.

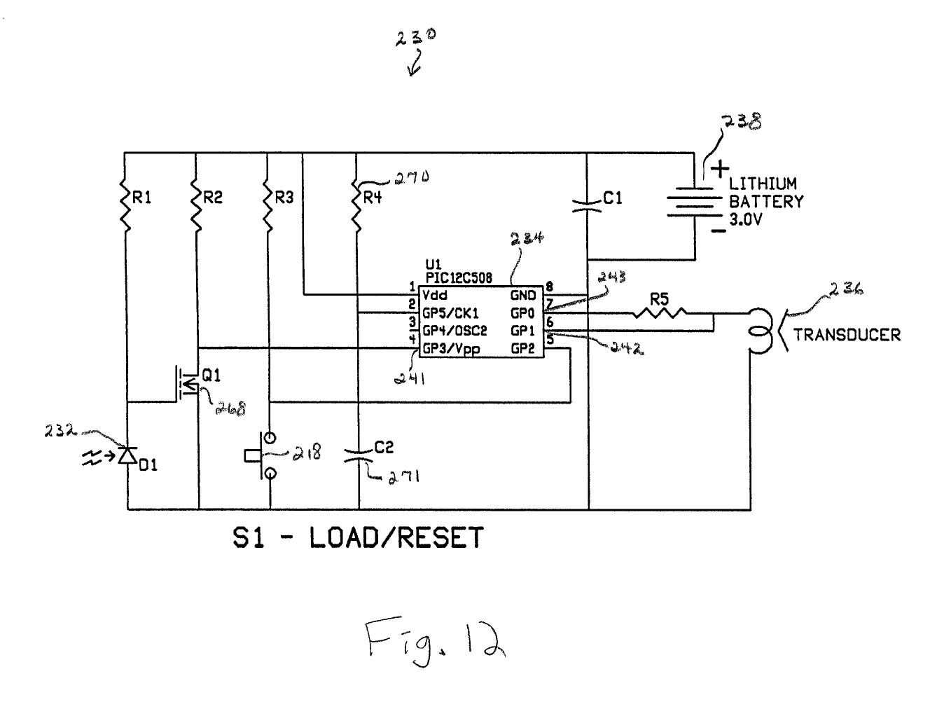

The time interval signal upload from the timer set assembly 202 to the alarm assembly 230 may be accomplished via magnetic induction. FIG. 13 depicts this alternate embodiment as additional circuit portions 276 and 278. Circuit portions 276 and 278 are integrated into the circuits described and disclosed in FIGS. 9-12. In this embodiment, a switch 280, a diode D1 282, a diode D2 283, and an output inductor 284 replace the first transistor switch 258 of FIG. 10. Serial data from the microcontroller 206 produces magnetic pulses rather than, e.g., infrared energy pulses. When the switch 280 is turned on, the output inductor 284 is energized and sets up a surrounding magnetic field. When the switch 280 is turned off, the magnetic field collapses. Any energy not collected by the receiving inductor in the present earpiece alarm assembly results in leakage inductance. The diodes 282 and 283 direct this unwanted energy away from the switch 280, thereby preventing its damage or destruction. The energy stored in the leakage inductance is dissipated in the diode D1 282.

When the present timer set assembly and earpiece are brought into close proximity, pulsing magnetic fields from the output inductor 284 in the timer set 276 assembly induce a variable voltage across the receiving inductor 288 in the earpiece circuit portion 278. These voltage pulses are compared to two thresholds (one threshold rising, one threshold falling) in the Schmidt Trigger Circuit 290. This comparison “cleans up” the data stream, which is then sent to the microcontroller of the earpiece.

Those of ordinary skill on the art will recognize that other methods exist for transmitting the data from the timer set assembly to the earpiece. These alternative methods include, but are not limited to, radio frequency and direct electrical connection.

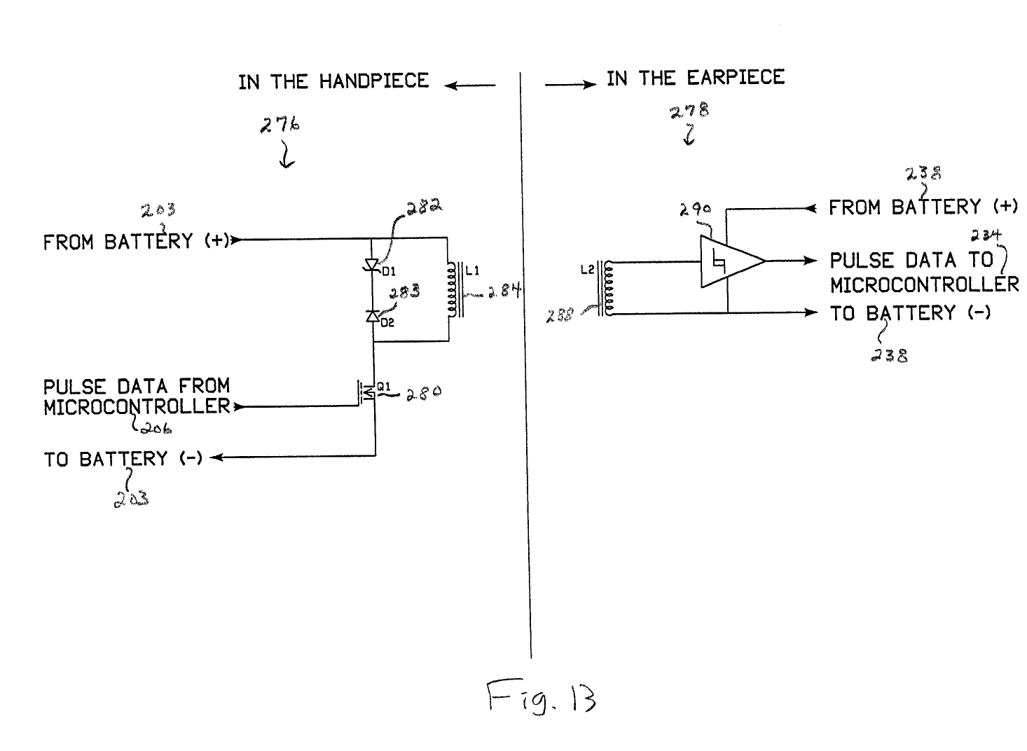

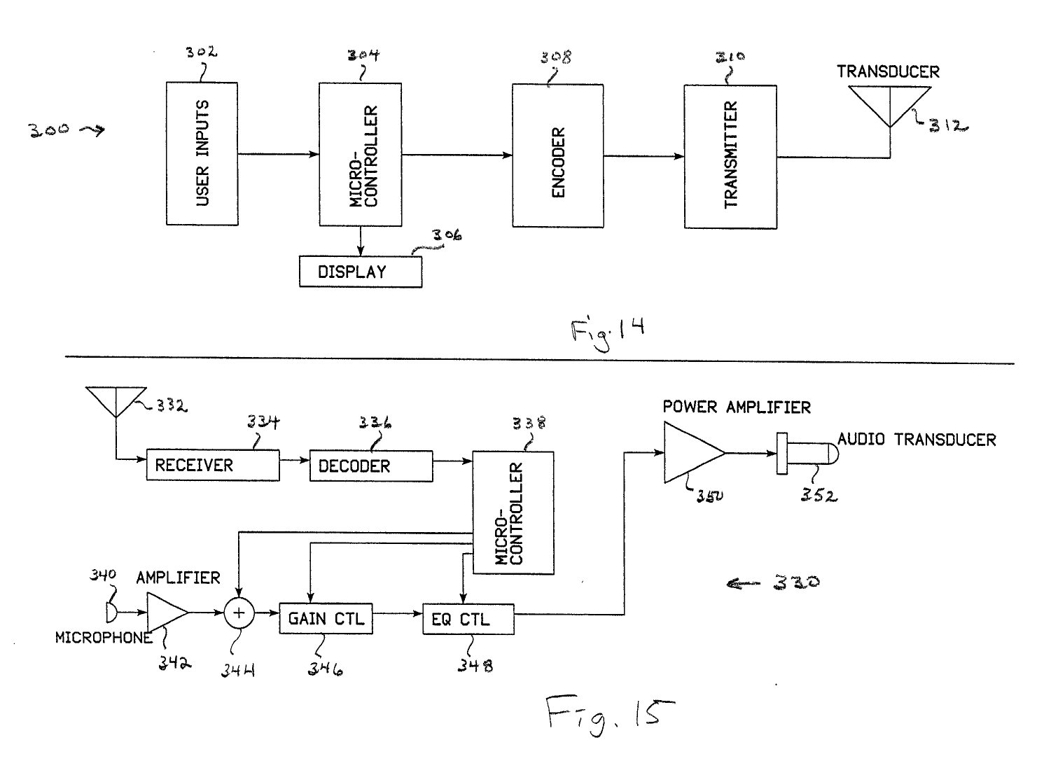

Referring to FIGS. 14 and 15, an alternative embodiment of the present invention is incorporated into a hearing assist/alarm device and controller. A hand set 300 for setting and controlling a hearing assist/alarm (described below), the hearing aid incorporating the alarm assembly, is shown at a component layout level. The hand set 300 includes user input controls 302, which are electrically connected to a microcontroller 304, a display 306, an encoder 308, a transmitter 310, and an emitter 312. The user inputs 302 include such parameters as time (e.g., hour, minute) interval settings, gain (volume) and equalization (tone quality).

The user input controls 302 are processed by the microprocessor 304, which presents the results of the user input on the display 306. The microprocessor 304 also produces a stream of digital data, which will be used to control functions in the present hearing assist/alarm device. The encoder 308 maybe imbedded in the microprocessor 304, or may optionally be a separate circuit element. The encoder 308 prepares the data from the user control inputs 302, via the microcontroller 304, for transmission to the present hearing assist/alarm device. The transmitter 310 sends the encoded data to an earpiece receiver (see below) by emitting a signal from the emitter 312 to be received by an ear piece receptor (see below). Radio frequency, infrared, or magnetic induction may be used as modes of transmission, for example, an antenna for radio frequency, an infrared light emitting diode for infrared, or a coil for magnetic induction. The embodiment depicted may employ the infrared emitter 312 and an earpiece receptor (see below). However, those of ordinary skill the art will recognize that radio frequency transmission and a magnetic field may be used as well.

Referring to FIG. 15, an electrical component layout for an exemplary hearing assist/alarm device (earpiece) 330 is shown. A receptor 332 is electrically connected to a receiver 334, a decoder 336, and a microcontroller 338. Additionally, a microphone 340 is connected to a conditioning amplifier 342, a summing circuit 344, a gain adjustment circuit 346, an equalization circuit 348, a power amplifier 350, and an audio transducer 352. The microcontroller 338 is also electrically connected to the summing circuit 344, the gain adjustment circuit 346, and the equalization circuit 348. The power source for the embodiment depicted in FIGS. 14 and 15 is not indicated. However, those of ordinary skill the art will readily recognize that a variety of suitable power sources, such as lithium batteries at appropriate voltages, maybe included without undue experimentation.

A device suitable for functioning as the receptor 332 for the earpiece 330 may be determined by the chosen communication method, e.g., radio frequency, infrared, or magnetic induction. The receiver 334 converts the receptor signals received by the receptor 332 from the emitter 312 to an electrical form suitable to be decoded by the decoder 336. The decoder 336 may be explicitly provided, or may be embedded in the microprocessor 338. The decoder 336 converts the received signals to a form which may be interpreted by the microcontroller 338 in order to control the internal functions of the earpiece 330. The microcontroller 338, based on the data received from the hand piece 300, produces output signals. The output signals are used to control the audio functions of the earpiece 330, e.g., gain and equalization.

The microphone 340 is provided to receive ambient sounds desired to be heard by the user. The conditioning amplifier 342 is provided to condition a signal from the microphone 340, so that the signal is usable to the gain circuit 346 and the equalization circuit 348. The summing circuit 342 gain adjustment circuit 346, and equalization circuit 348 are be controlled by the controller 338 in one embodiment. The power amplifier 350 increases the magnitude of the audio signal as perhaps required to operate the audio transducer 352. In one embodiment, the audio transducer 352 is an electro-dynamic transducer that converts the electrical signal from the power amplifier 350 to an acoustical signal, which may be heard by the user.

The hand piece of FIG. 14 can be further modified to function as a timer set assembly of this invention by adding a plurality of time set input devices, such as those described with respect to FIGS. 9 and 10. The microcontroller 304 may contain additional programming to accept the time interval control inputs and convert these inputs to control codes, as perhaps required by the earpiece 330. The display 306 may display the selected time interval entered by the user, in addition to other information. The microcontroller 338 of the earpiece 330 may contain additional programming, e.g., to count down the prescribed time interval upon receipt of a time interval command from the hand set 300. At the required moment, the microcontroller 338 may output an electrical signal, which, when converted to an acoustical signal by the audio transducer 352, will have an alerting or alarming quality to the user. This signal may persist for a preset period of time, optionally determined by the user as well. In one embodiment, the signal can be terminated by the user by actuating a set device, as described above.

The summing circuit 344, described with respect to FIG. 15, maybe included in the electrical connection between the amplifier 342 and the gain adjustment circuit 346. In one embodiment, the summing circuit 344 allows the alarm signal (described above) to be combined with, or added to, the normal audio signal of the present hearing aid.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. A timer alarm apparatus, comprising:
a timer setting assembly generating a time interval signal in response to a user determined amount of time; and
an alarm assembly configured to receive the time interval signal, determine the user determined amount of time in response to the time interval signal, and deliver an auditory alarm to an auditory canal of a user at completion of the user determined amount of time, the alarm assembly including a timer circuit and an alarm tone generation assembly in electrical communication with the timer circuit.

2. The timer alarm apparatus of claim 1, further comprising a first power source, and
wherein the timer setting assembly programmably inputs the user determined amount of time into the timer circuit of the alarm assembly, the timer circuit of the alarm assembly detecting a lapse of the user determined amount of time and triggering the alarm tone generation assembly to produce an audible alarm tone in response to the lapse of the user determined amount of time, the first power source providing electrical power to the timer circuit and alarm tone generation assembly.

3. The timer alarm apparatus of claim 2, wherein the timer setting assembly includes a second power source, a voltage regulator operatively connected to the power source, a microcontroller operatively connected to the voltage regulator, a serial-parallel converter operatively connected to the microcontroller, and a plurality of set switches in electrical communication with the microcontroller.

4. The timer alarm of claim 3, wherein the plurality of set switches includes an hour set switch, a minute set switch and a set time transmission switch.

5. The timer alarm of claim 2, wherein the alarm assembly is configured to be at least partially insertable into the auditory canal of the user.

6. The timer alarm of claim 5, wherein the alarm assembly is configured to reduce the introduction of environmental noise into the auditory canal of the user.

7. The timer alarm of claim 2, wherein the timer setting assembly further includes a predetermined time output circuit portion.

8. The timer alarm of claim 2, wherein the timer setting assembly outputs the user determined amount of time to the alarm assembly through a magnetic carrier wave.

9. The timer alarm of claim 2, wherein the timer setting assembly outputs the user determined amount of time to the alarm assembly through an infrared carrier wave.

10. The timer alarm of claim 2, wherein the timer setting assembly outputs the user determined amount of time to the alarm assembly through a radio frequency carrier wave.

11. The timer alarm of claim 2, wherein the timer setting assembly outputs the user determined amount of time to the alarm assembly through a direct electrical connection.

12. A method of providing a timed alarm, the method comprising:
providing an alarm timer assembly configured to be at least partially accommodated within an auditory canal of a user;
providing a timer setting assembly with a plurality of input devices;
inputting a desired amount of time into the timer setting assembly via said input devices;
transmitting the desired amount of time from the timer setting assembly to the alarm timer assembly; and
placing the timer set assembly at least partially within the auditory canal of the user.

13. The method of claim 12, wherein the plurality of input devices includes a minute set device, an hour set device and an alarm time transfer device and wherein inputting the desired amount of time into the timer set assembly includes inputting desired minutes and hours by operating the minute set device, the hour set device, and the alarm transfer device.

14. The method of claim 12, wherein the desired amount of time is communicated to the alarm timer assembly through a magnetic field.

15. The method of claim 12, wherein the desired amount of time is communicated to the alarm timer assembly through a infrared carrier wave.

16. The timer alarm of claim 12, wherein the timer setting assembly outputs the user determined amount of time to the alarm assembly through a radio frequency carrier wave.

17. The timer alarm of claim 12, wherein the timer setting assembly outputs the user determined amount of time to the alarm assembly through a direct electrical connection.

18. An alarmable hearing aid comprising:
an earpiece configured to be at least partially disposed within an auditory canal of a user, the earpiece including a microphone, a sound detection circuit, an amplifier operably connected to the sound detection circuit, a sound emission apparatus operably connected to the amplifier, a timing apparatus operably connected to the sound emission apparatus and an alarm assembly operably connected to the timing apparatus, the timing apparatus and alarm assembly communicating an audible alarm signal to the user's auditory passage upon completion of a predetermined amount of time.

19. The hearing aide of claim 18, further comprising a remote timer set assembly configured to provide the timing apparatus with a signal corresponding to the predetermined amount of time.

20. A timer alarm apparatus comprising:
a timer setting assembly, including means for setting a user determined amount of time and including means for transmitting a time internal signal corresponding to the user determined amount of time; and
an alarm at least partially insertable into a user's auditory canal, including means for emitting an alarm signal into the user's auditory canal upon completion of the user determined amount of time and including means for receiving the time internal signal.

21. The timer alarm apparatus of claim 20, wherein the receiving means includes means for sensing infrared radiation and the means for transmitting includes means for generating infrared radiation.

22. The timer alarm apparatus of claim 20, wherein the receiving means includes means for sensing an electromagnetic field and the means for transmitting includes means for generating an electromagnetic field.

23. The timer alarm apparatus of claim 20, wherein the receiving means includes means for sensing an electromagnetic field and the means for transmitting includes means for generating radio frequencies.

24. The timer alarm apparatus of claim 20, wherein the receiving means includes means for sensing an electromagnetic field and the means for transmitting includes means for directly electrically connecting the timer setting assembly to the alarm.

25. The timer alarm apparatus of claim 20, wherein the alarm signal emitting means includes means for creating audible tones.

26. A hearing aid comprising:
an earpiece configured to communicate with an auditory passage of a user and including means for detecting sound, means for amplifying sound detected by the detecting means, means for emitting sound amplified by the sound amplifying means, means for timing, and means for emitting an alarm in the auditory passage in response to the timing means.
